(19) United States
(12) Patent Application Publication
(10) Pub. No.: US 2012/0169568 A1
(43) Pub. Date: Jul. 5, 2012

(54) MULTIBAND ANTENNA WITH GROUND RESONATOR AND TUNING ELEMENT

(75) Inventors: Sung-Hoon Oh, Cupertino, CA (US); Thomas Liu, Sunnyvale, CA (US); Thorsten Hertel, San Jose, CA (US)

(73) Assignee: PALM, INC., Sunnyvale, CA (US)

(21) Appl. No.: 12/983,695

(22) Filed: Jan. 3, 2011

(51) Int. Cl. H01Q 21/30

(52) U.S. Cl. 343/893

(57) ABSTRACT

Various embodiments of an antenna structure for mobile devices are described. In one or more embodiments a multi-band antenna includes first, second and third resonating elements. The first and second resonating elements may each have an L-shape, and may be fed by a single feed leg. The third resonating element may be coupled to ground. In some embodiments, the first resonating element may be longer than the second resonating element, and the third resonating element may be positioned adjacent to the first resonating element. In other embodiments, a tuning element is coupled to the signal feed and is positioned adjacent to the second resonating element. The tuning element may have a geometry that is similar to a geometry of the second resonating element. The combination of these structures creates a plurality of distinct resonance modes which creases a wide effective bandwidth for the disclosed antenna. Other embodiments are described and claimed.

### BACKGROUND

A mobile computing device such as a combination handheld computer and mobile telephone or smart phone generally may provide voice and data communications functionality, as well as computing and processing capabilities. Such mobile computing devices rely on antenna designs that are severely constrained by space, volume and other mechanical limitations. Such constraints result in less than desired performance. Accordingly, there may be a need for an improved antenna for use with mobile computing devices. Such an improved antenna should provide good efficiency and gain patterns and should fit within space, volume and mechanical constraints associated with modern handset architectures. The improved antenna should be a simple and low-profile structure for mobile handsets, and should enable wide band frequency response and a unique antenna pattern without compromising antenna size or efficiency.

### BRIEF DESCRIPTION OF THE DRAWINGS

FIGS. 1 and 2 illustrate a mobile computing device in accordance with one or more embodiments.

FIG. 3 illustrates a position of an antenna element with respect to a PCB board according to one or more embodiments.

FIG. 4 illustrates a position of an antenna element with respect to a PCB board according to one or more embodiments

FIG. 5 illustrates a matching circuit in accordance with one or more embodiments.

FIG. 6 illustrates a frequency plot relating to an antenna element according to one or more embodiments.

FIG. 7 illustrates a position of an antenna element with respect to a PCB board according to one or more embodiments.

FIG. 8 illustrates a position of an antenna element with respect to a PCB board according to one or more embodiments.

FIG. 9 illustrates a matching circuit in accordance with one or more embodiments.

FIG. 10 illustrates a frequency plot relating to an antenna element according to one or more embodiments.

FIG. 11 illustrates a system in accordance with one or more embodiments.

### DETAILED DESCRIPTION

Current and next-generation wireless mobile devices use wide-band and multi-band antennas. Due to fundamental gain-bandwidth limitations of antennas of limited size, however, antenna structure poses a limit to ever shrinking and ever complicated mobile device designs. Moreover, when designing antennas for mobile devices, avoiding complicated antenna structures may be desirable in order to reduce engineering costs, cycle times, and product reliability issues. To address these issues, a multi-band antenna is disclosed having a simple, low-profile structure for use in mobile devices. The antenna enables wide band frequency response without compromising antenna size and system efficiency.

Various embodiments are directed to a multi-band antenna comprising first and second resonating elements, a signal feed coupled to the first and second resonating elements, and a ground conductor coupled to a third resonating element. In some embodiments the first and second resonating elements have first and second portions configured in an L-shape. In other embodiments, the third resonating element positioned adjacent to the first resonating element. In still further embodiments, a tuning element is electrically coupled to the signal feed. The tuning element may be positioned adjacent the second resonating element, and may have a geometry that is substantially the same as a geometry of the second resonating element.

In some embodiments, a mobile computing device includes an applications processor, a radio processor, a display, and an antenna. The antenna may comprise first and second resonating elements electrically coupled to a signal feed, and a third resonating element coupled to a ground conductor. In some embodiments, each of the first and second resonating elements having a first portion and a second portion configured in an L-shape. In other embodiments, a tuning element may be electrically coupled to the signal feed and positioned adjacent to the second resonating element, the tuning element having a geometry substantially the same as a geometry of the second resonating element.

In some embodiments, an antenna comprises first, second and third resonating elements. The first and second resonating elements may each have an L-shape. A signal feed may be coupled to the first and second resonating elements. A ground conductor may be coupled to the third resonating element. Some embodiments include a tuning element coupled to the signal feed.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

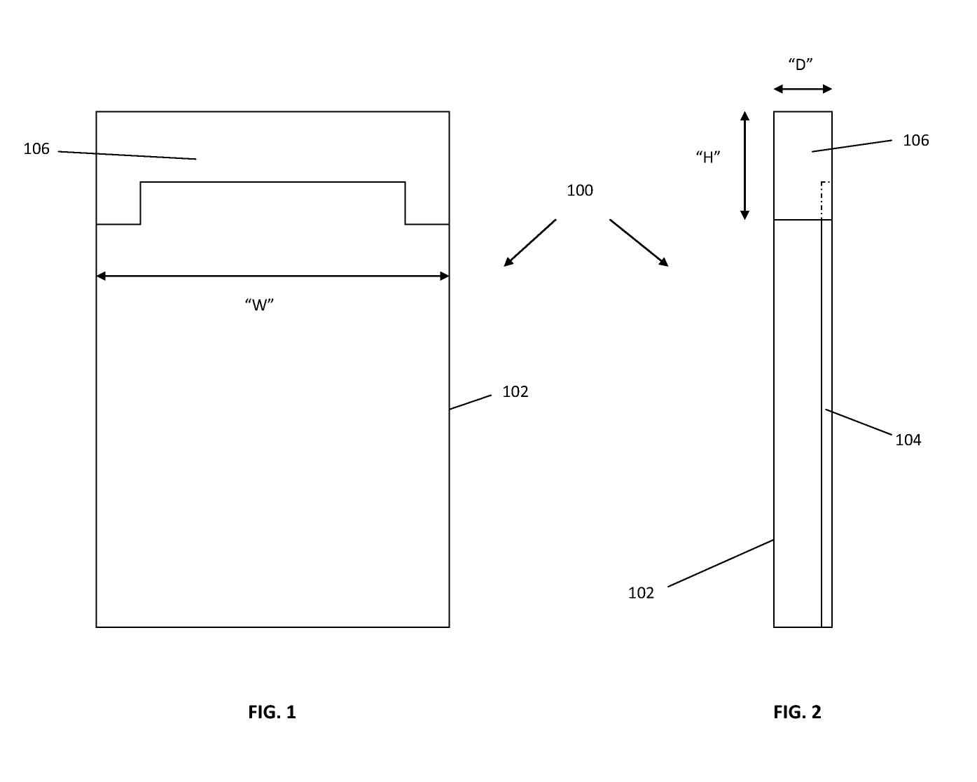

FIGS. 1 and 2 illustrate an embodiment of a wireless device 100 having an internal antenna architecture. The wireless device 100 may comprise, or be implemented as, a handheld computer, mobile telephone, personal digital assistant (PDA), combination cellular telephone/PDA, data transmission device, one-way pager, two-way pager, and so forth. Although some embodiments may be described with wireless device 100 implemented as a handheld computer by way of example, it will be appreciated that other embodiments may be implemented using other wireless handheld devices as well.

In various embodiments, the wireless device 100 may comprise a housing 102 and a printed circuit board (PCB) 104. The housing 102 may include one or more materials such as plastic, metal, ceramic, glass, and so forth, suitable for enclosing and protecting the internal components of the wireless device 100. The PCB 104 may comprise materials such as FR4, Rogers R04003, and/or Roger RT/Duroid, for example, and may include one or more conductive traces, via structures, and/or laminates. The PCB 104 also may include a finish such as Gold, Nickel, Tin, or Lead. In various implementations, the PCB 104 may be fabricated using processes such as etching, bonding, drilling, and plating.

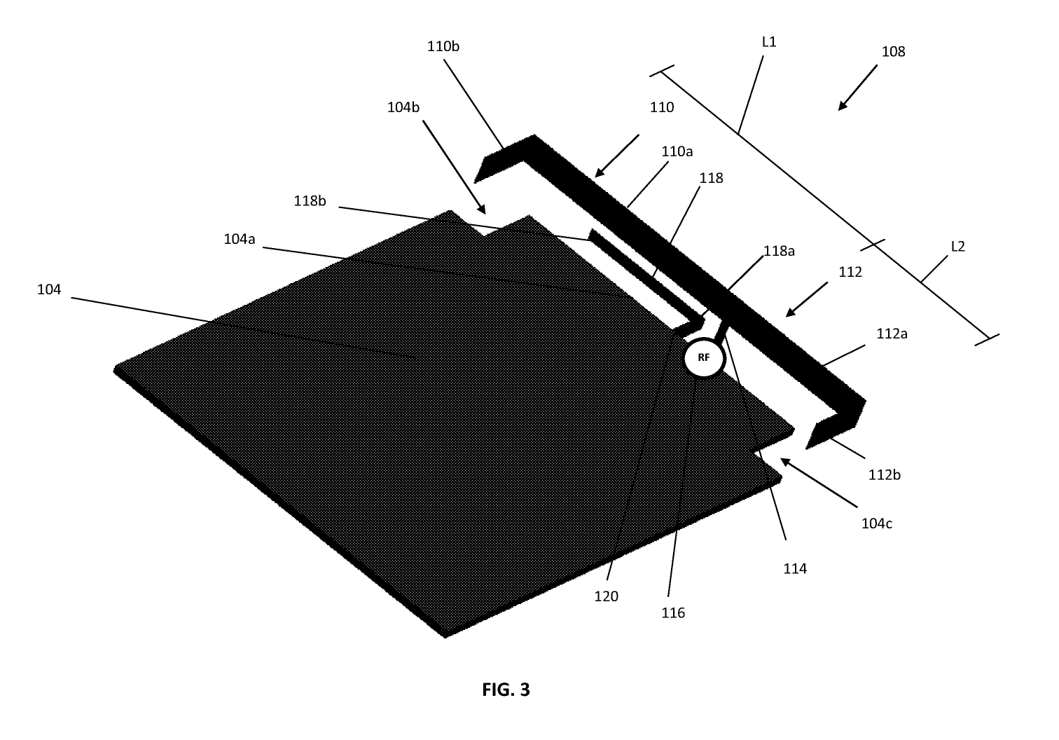

The device 100 may include a “keep-out” area 106 at or near one end of the housing 102. The keep-out area 106 may be a portion of the device housing 102 that the PCB 104 does not occupy. In the illustrated embodiment, however, the “keep-out” area 106 houses the disclosed antenna structure 108 (see, e.g., FIG. 3). As will be discussed in greater detail later, the size and arrangement of the disclosed antenna structure 108 is constrained by the size of the keep-out area 106, and thus it is desirable that the antenna structure 108 provide a desired performance in as small a form factor as practical.

In various embodiments, wireless device 100 may comprise elements such as a display, an input/output (I/O) device, a processor, a memory, and a transceiver, for example. One or more elements may be implemented using one or more circuits, components, registers, processors, software subroutines, modules, or any combination thereof, as desired for a given set of design or performance constraints.

The display may be implemented using any type of visual interface such as a liquid crystal display (LCD), a touch-sensitive display screen, and so forth. The I/O device may be implemented, for example, using an alphanumeric keyboard, a numeric keypad, a touch pad, input keys, buttons, switches, rocker switches, a stylus, and so forth. The embodiments are not limited in this context.

The processor may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In some embodiments, for example, the processor may be implemented as a general purpose processor, such as a processor made by Intel® Corporation, Santa Clara, Calif. The processor also may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

The memory may be implemented using any machine-readable or computer-readable media capable of storing data, including both volatile and non-volatile memory. The memory may be non-transient computer-readable media (e.g., memory or storage). Memory may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory may be included on the same integrated circuit as a processor, or alternatively some portion or all of memory may be disposed on an integrated circuit or other medium, for example a hard disk drive, that is external to the integrated circuit of a processor. The embodiments are not limited in this context.

The transceiver may be implemented, for example, by any transceiver suitable for operating at a given set of operating frequencies and wireless protocols for a particular wireless system. For example, the transceiver may be a two-way radio transceiver arranged to operate in the 824-894 MHz frequency band (GSM), the 1850-1990 MHz frequency band (PCS), the 1575 MHz frequency band (GPS), the 824-894 MHz frequency band (NAMPS), the 1710-2170 MHz frequency band (WCDMA/UMTS), or other frequency bands.

In various embodiments, an antenna may be electrically connected to a transceiver operatively associated with a signal processing circuit or processor positioned on a PCB. In order to increase power transfer, the transceiver may be interconnected to an antenna such that respective impedances are substantially matched or electrically tuned to compensate for undesired antenna impedance. In some cases, the transceiver may be implemented as part of a chip set associated with a processor. The embodiments are not limited in this context.

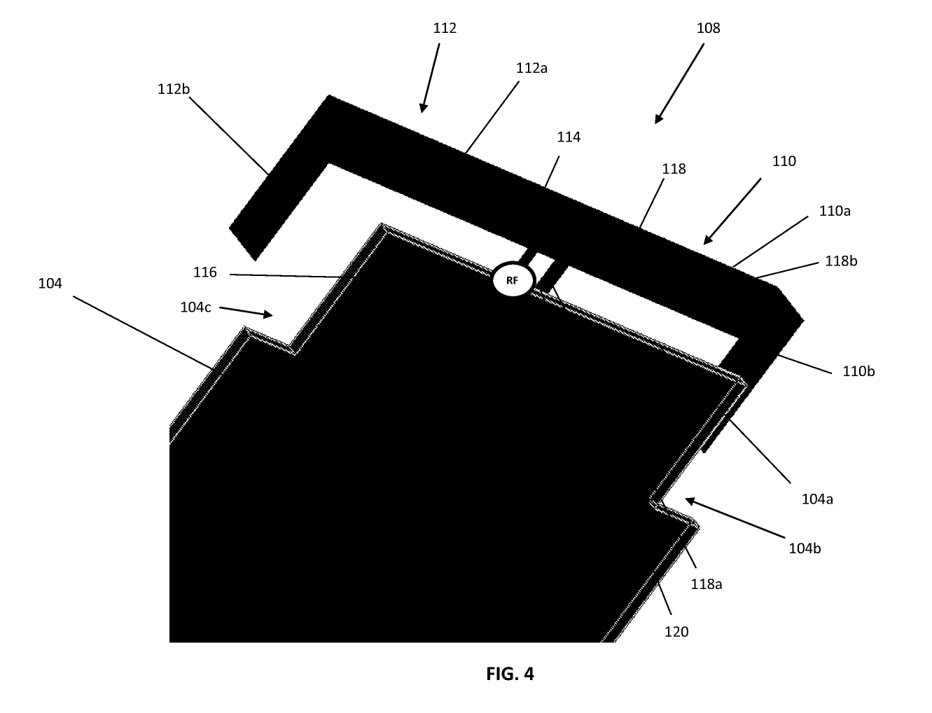

Referring now to FIGS. 3 and 4, PCB 104 and antenna structure 108 of device 100 are shown in adjacent relation. The antenna structure may 108 may include a plurality of resonating elements or “arms” which in operation may resonate at one or more frequencies to provide a desired bandwidth. In the illustrated embodiment, the antenna structure 108 comprises first and second resonating elements 110, 112 which are electrically coupled together at a feed leg 114. The feed leg 114 is coupled to an electrical feed structure 116 associated with the PCB 104. The feed structure 116 may be a coaxial cable, microstrip line slot line, coplanar waveguide, parallel transmission line, or the like. As will be described in greater detail later, the feed structure 116 may be coupled to an impedance matching circuit which, in turn, may be coupled to an associated transceiver.

The first and second resonating elements 110, 112 each may have a first portion 110a, 112a oriented substantially parallel to a top edge 104a of the PCB 104. The first and second resonating elements 110, 112 may further each have a second portion 110b, 112b connected to respective distal ends of the first portions 110a, 112a. The second portions 110b, 112b may be oriented substantially perpendicular to the first portions and to the top edge 104a of the PCB 104 to create two L-shaped resonating elements. The second portions 110b, 112b may be oriented so that their distal ends extend back toward the PCB 104 to provide a compact arrangement.

The PCB 104 may include cut-out portions 104b, 104c that underlie the second portions 110b, 112b of the antenna structure 108. These cut-out portions 104b, 104c may be about the same size as the second portions 110b, 112b. Providing the cut-out portions 104b may minimize or eliminate interference by the PCB 104 with the antenna structure 108 along its full length.

In an exemplary embodiment, the length L1 (see FIG. 3) of the first portion 110a of the first resonating element is greater than the length L2 of the first portion 112a of the second resonating element. This arrangement may result in two separate resonances in operation, which may provide the antenna structure 108 with a wider bandwidth as compared to prior designs. It will be appreciated, however, that some embodiments may include an arrangement of the first and second resonating elements 110, 112 in which L2 is greater than L1. In still other embodiments, L1 may be equal to L2.

The antenna structure 108 may also include a ground resonator element 118. The ground resonator element 118 may have a first portion 118a coupled to a ground plane portion 120 of the PCB 104 to “short” the ground resonator element 118 to ground. In the illustrated embodiment, the first section 118a is oriented perpendicular to the top edge 104a of the PCB. The ground resonator element may have a second section 118b oriented parallel to the top edge 104a of the PCB. Thus arranged, the second section 118b may be positioned adjacent to the first section 110a of the first resonating element 110. This arrangement may cause the first resonating element 110 and the ground resonator element 118 to produce an additional resonance in operation, which may provide the antenna structure 108 with a wider bandwidth as compared to prior designs.

Thus arranged, the disclosed antenna structure 108 may provide a low-Q multi-resonating structure providing wide bandwidth for both low and high bands. It will be appreciated that the illustrated arrangement is exemplary, and that other arrangements of the first and second resonating elements 110, 112 and ground resonator element 118 can also be used to achieve a desired wide bandwidth.

The disclosed antenna structure 108 also may be implemented in the small volume “keep out” area 106 of mobile device 100. In one embodiment, the disclosed antenna structure 108 may fit within a keepout area 106 having dimensions of about 60 millimeters (mm) wide (“W”), about 10 mm high (“H”), and about 7 mm deep (“D”) (see FIGS. 1 and 2).

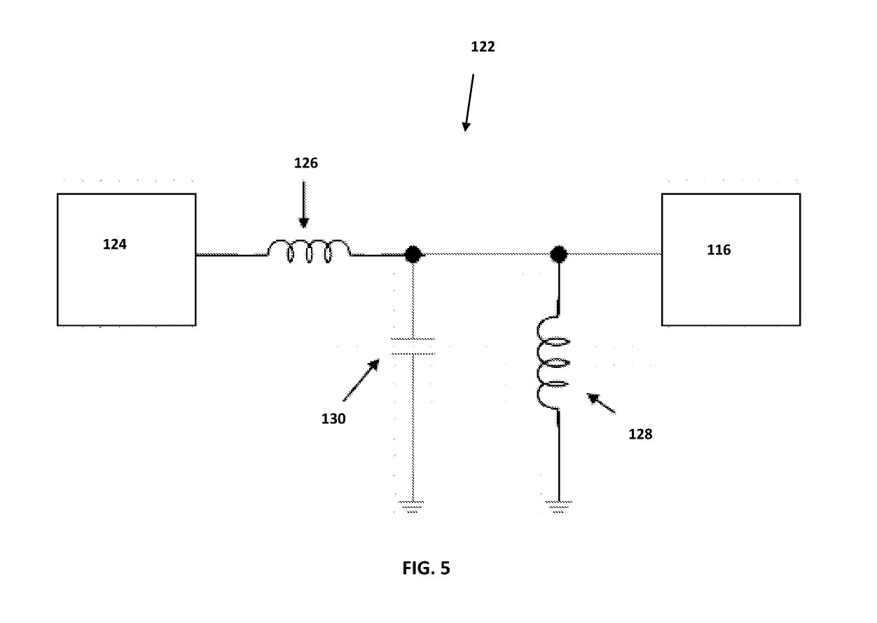

FIG. 5 shows an exemplary matching circuit 122 for use with the antenna structure of FIGS. 3 and 4. The matching circuit 122 may couple the feed structure 116 of the PCB 104 to an output from a transceiver 124. The matching circuit 122 may include components useful for matching an impedance of the transceiver 124 to an impedance of the antenna structure 108 over a wide frequency range. In some embodiments, the matching circuit 122 may include first and second inductors 126, 128 and a capacitor 130. In the illustrated embodiment, the feed structure 116 may be coupled in series with the first inductor 126, and may also be coupled in parallel with the second inductor 128 and the capacitor 130. In one non-limiting exemplary embodiment, the first and second inductors 126, 128 may have respective inductances of 3 and 5.5 nanoHenrys (nH), while the capacitor 128 may have a capacitance of 2 picoFarads (pF). It will be appreciated that this is but one exemplary implementation of a matching circuit 122 for the antenna structure 108, and that others may also be used.

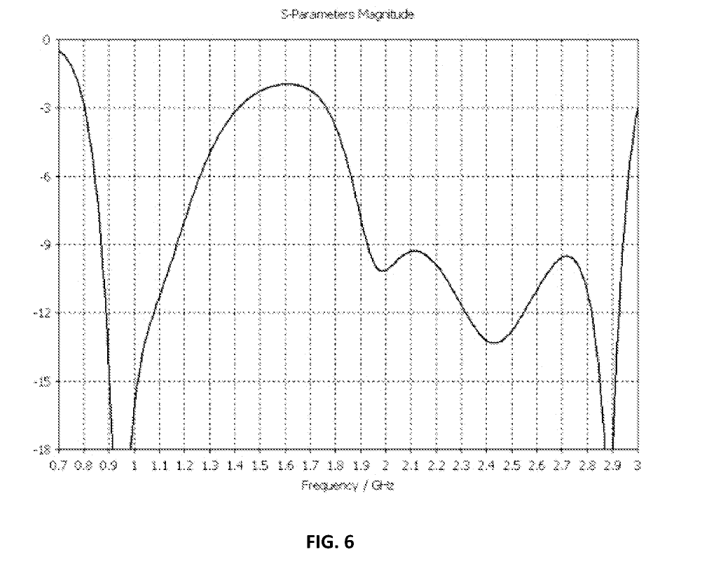

FIG. 6 shows a frequency plot relating to embodiments of the disclosed antenna structure 108 of device 100. As can be seen, the disclosed arrangement may result in three separate resonances. The first resonance may be produced by the first resonating element 110, the second resonance may be produced by the second resonating element 112, and the third resonance may be produced by the coupling between the first resonating element and the grounded resonator element 118. In the illustrated embodiment, the first resonance may be about 2 GHz, the second resonance may be about 2.4 GHz, and the third resonance may be about 2.9 GHz. It will be appreciated that these values are exemplary, and that for some embodiments other resonance values may be produced. Thus, some embodiments of the above-described arrangement of resonating elements may provide the antenna structure 108 with an operational range of from about 1.85 GHz to about 2.95 GHz. It will be appreciated, however, that the resonating elements 110, 112 and 118 can be provided in different sizes, shapes and arrangements to result in other desired resonance values.

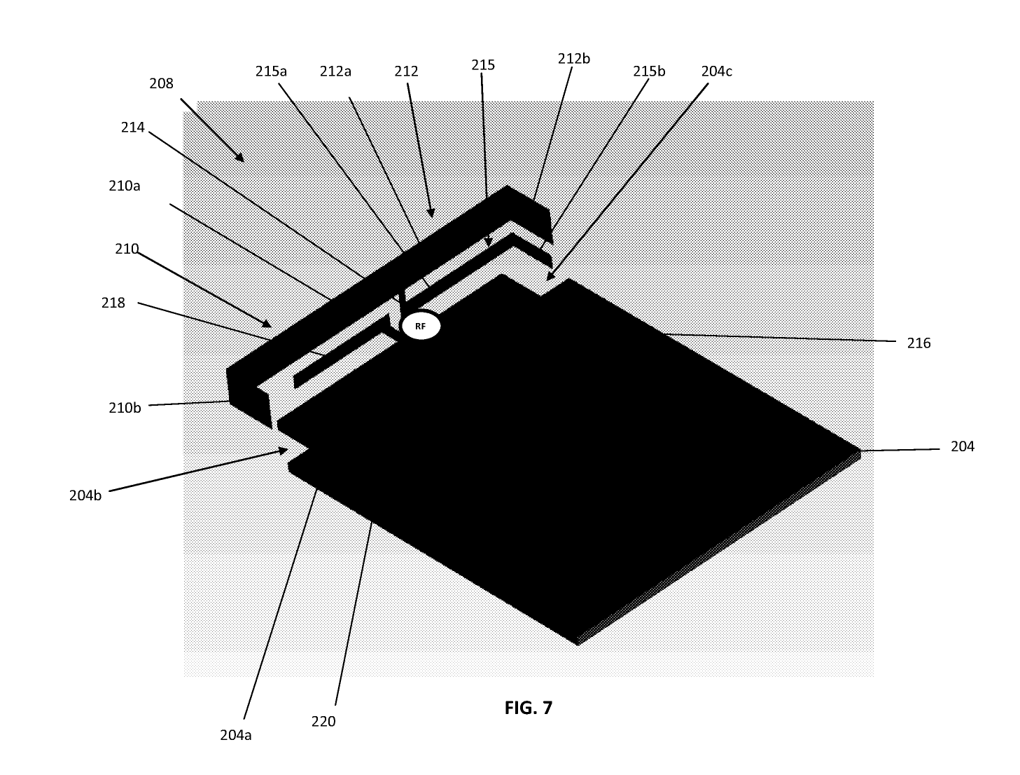

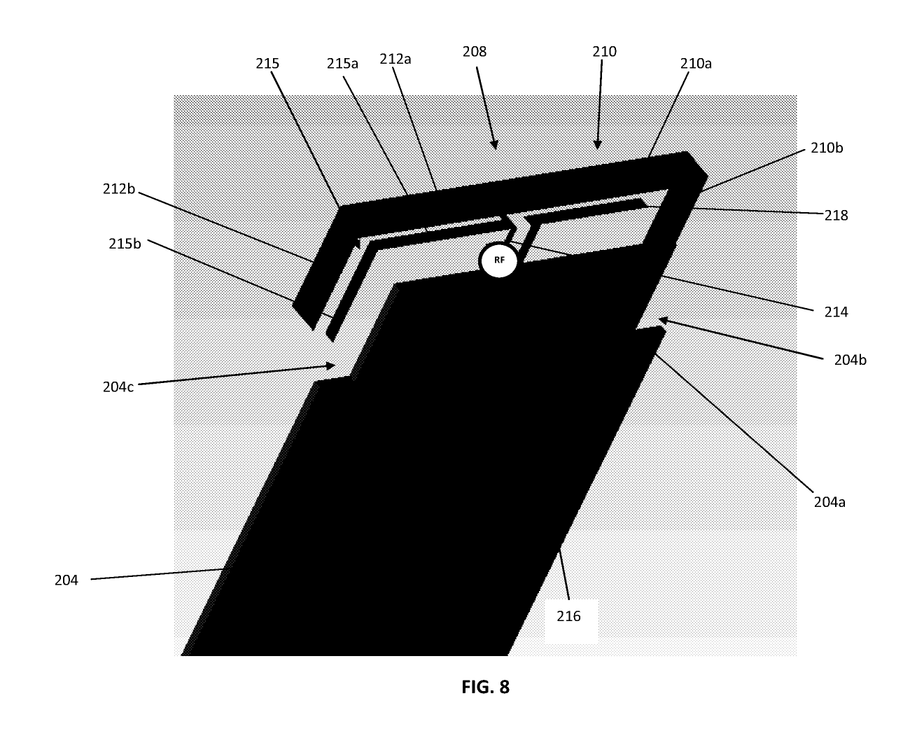

Referring now to FIGS. 7 and 8, an embodiment of a PCB 204 and antenna structure 208 for use in device 100 are shown. The antenna structure 208 may include first and second resonating elements 210, 212 configured and arranged in the manner described in relation to the embodiments of FIGS. 3 and 4 (including, for example, first and second portions 210a, 210b, 212a, 212b, oriented in L-shaped arrangements). In addition, the antenna structure 208 may include a ground resonator element 218 connected to a ground plane portion 220 of the PCB 204. PCB 204 may have a top edge 204a, and first and second cutouts 204b, 204c similar to those described in relation to the previous embodiments.

The first and second resonating elements 210, 212 may be electrically coupled together at a feed leg 214. The feed leg 214 may be coupled to an electrical feed structure 216 associated with the PCB 204. The feed structure 116 may be a coaxial cable, microstrip line slot line, coplanar waveguide, parallel transmission line, or the like. The feed structure 216 may be coupled to an impedance matching circuit which, in turn, may be coupled to an associated transceiver.

The details and arrangement of the first and second resonating elements 210, 212 and the ground resonator element 218 may be obtained by reference to the description of the prior embodiment, and thus will not be reiterated here.

The disclosed antenna structure 208 may further include a tuning element 215 coupled to the feed leg 214 for the first and second resonating elements 210, 212. In this manner, the tuning element 215 is directly fed by the same signal used to feed the first and second resonating elements. In the illustrated embodiment, the tuning element 215 includes a first section 215a oriented substantially parallel to the top edge 204a of the PCB 204, and a second section 215b oriented substantially perpendicular to the top edge 204a of the PCB 205. In some embodiments, the tuning element 215 is positioned adjacent to the first and second sections 212a, 212b of the second resonating element 212. The tuning element may have the same general geometry (i.e., L-shape) as the first or second section to which it is adjacent.

As will be appreciated, the tuning element 215, combined with the single feed leg 214 for the first and second resonating elements 210, 212 and the coupled ground resonator element 218, may provide highband tuning capability which facilitates wider highband bandwidth. As will also be appreciated, the size, length and arrangement of the tuning element 215 may be adjusted to tune the resonance at which the second resonating element resonates.

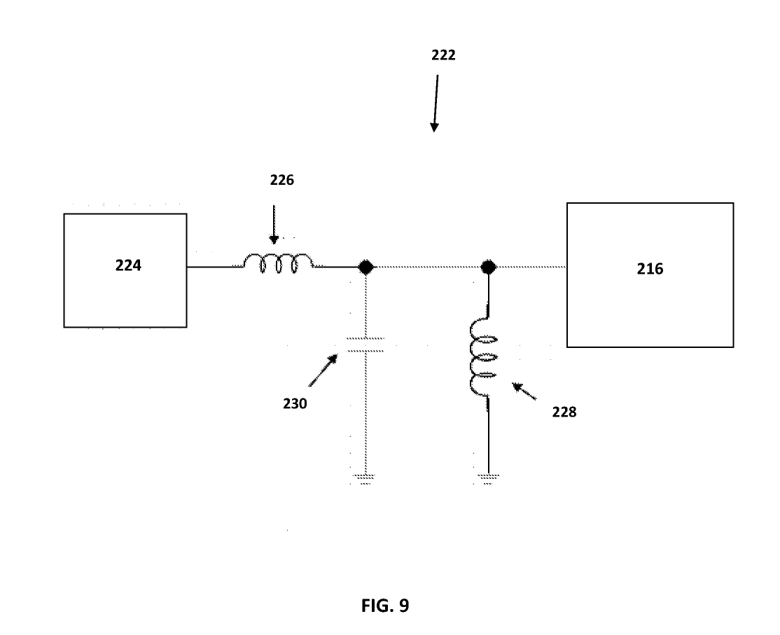

FIG. 9 shows an exemplary matching circuit 222 for use with the antenna structure of FIGS. 7 and 8. The matching circuit 222 may couple the feed structure 216 of the PCB 204 to an output from a transceiver 224. The matching circuit 222 may include components useful for matching an impedance of the transceiver 224 to an impedance of the antenna structure 208 over a wide frequency range. In some embodiments, the matching circuit 222 may include first and second inductors 226, 228 and a capacitor 230. In the illustrated embodiment, the feed structure 216 may be coupled in series with the first inductor 226, and may also be coupled in parallel with the second inductor 228 and the capacitor 230. In one non-limiting exemplary embodiment, the first and second inductors 226, 228 may have respective inductances of 2.2 and 5.5 nanoHenrys (nH), while the capacitor 228 may have a capacitance of 2.2 picoFarads (pF). It will be appreciated that this is but one exemplary implementation of a matching circuit 222 for the antenna structure 208, and that others may also be used.

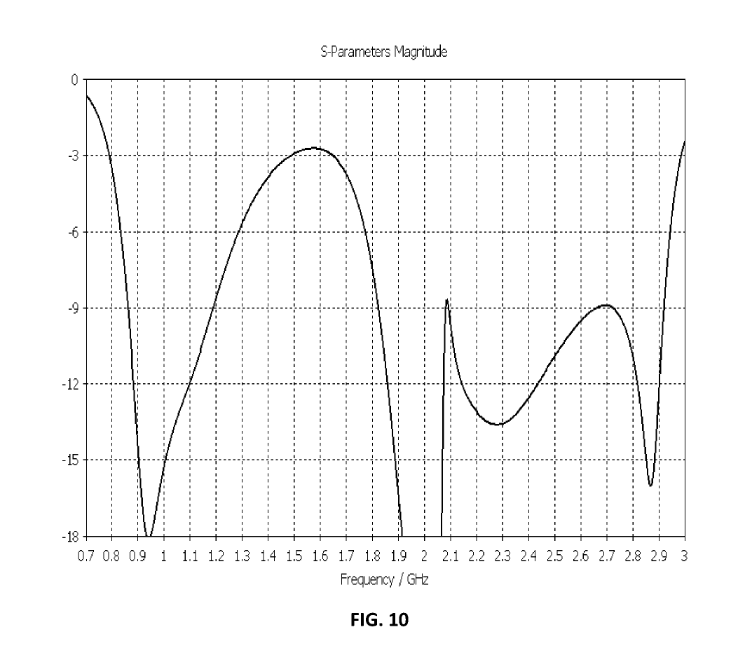

FIG. 10 shows a frequency plot relating to embodiments of the disclosed antenna structure 208 of device 100. As can be seen, the disclosed arrangement may result in three separate resonances. The first resonance may be produced by the first resonating element 210, the second resonance may be produced by the second resonating element 212, and the third resonance may be produced by the coupling between the first resonating element and the grounded resonator element 218. In the illustrated embodiment, the first resonance may be about 2 GHz, the second resonance may be about 2.3 GHz, and the third resonance may be about 2.85 GHz. It will be appreciated that these values are exemplary, and that for some embodiments other resonance values may be produced. Thus, some embodiments of the above-described arrangement of resonating elements may provide the antenna structure 208 with an operational range of from about 1.75 GHz to about 2.95 GHz. It will be appreciated, however, that the resonating elements 210, 212 and 218 and the tuning element 215 can be provided in different sizes, shapes and arrangements to result in other desired resonance values.

As with the previous embodiment, the disclosed antenna structure 208 may be implemented in the small volume “keep out” area 106 of mobile device 100. In one embodiment, the disclosed antenna structure 108 may fit within a keepout area 106 having dimensions of about 60 millimeters (mm) wide (“W”), about 10 mm high (“H”), and about 7 mm deep (“D”) (see FIGS. 1 and 2).

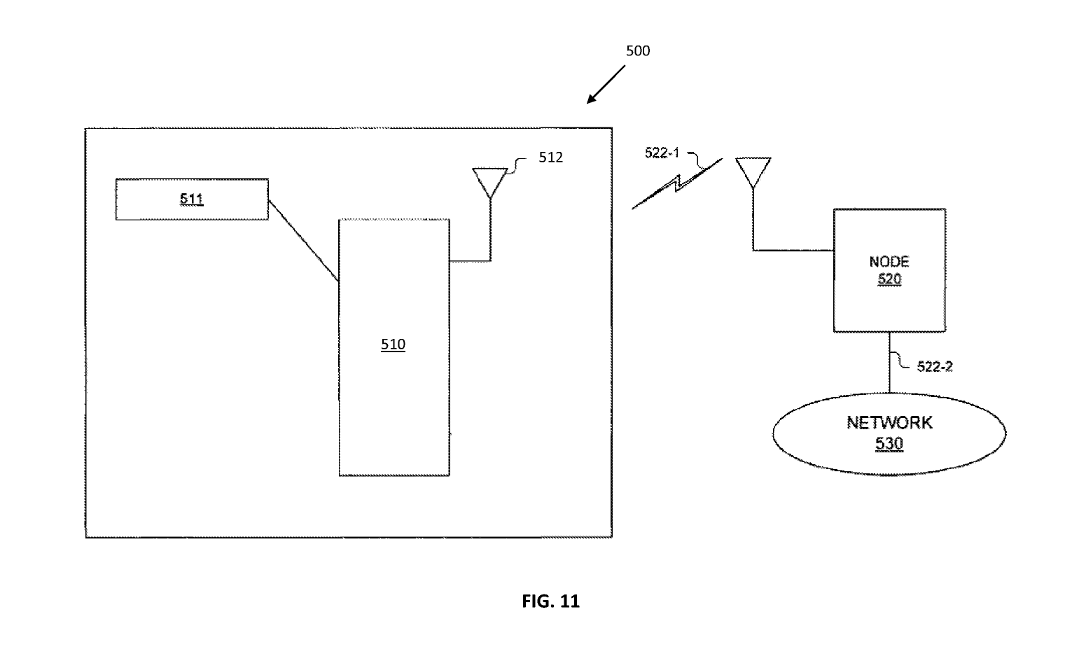

FIG. 11 illustrates one embodiment of a communications system 500 having multiple nodes. A node may comprise any physical or logical entity for communicating information in the communications system 500 and may be implemented as hardware, software, or any combination thereof, as desired for a given set of design parameters or performance constraints. Although FIG. 11 is shown with a limited number of nodes in a certain topology, it may be appreciated that communications system 500 may include more or less nodes in any type of topology as desired for a given implementation. The embodiments are not limited in this context.

In various embodiments, a node may comprise a processing system, a computer system, a computer sub-system, a computer, a laptop computer, an ultra-laptop computer, a portable computer, a handheld computer, a PDA, a cellular telephone, a combination cellular telephone/PDA, a microprocessor, an integrated circuit, a PLD, a DSP, a processor, a circuit, a logic gate, a register, a microprocessor, an integrated circuit, a semiconductor device, a chip, a transistor, and so forth. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

Communications system 500 may be implemented as a wired communication system, a wireless communication system, or a combination of both. Although system 500 may be illustrated using a particular communications media by way of example, it may be appreciated that the principles and techniques discussed herein may be implemented using any type of communication media and accompanying technology. The embodiments are not limited in this context.

When implemented as a wired system, for example, communications system 500 may include one or more nodes arranged to communicate information over one or more wired communications media. Examples of wired communications media may include a wire, cable, PCB, backplane, switch fabric, semiconductor material, twisted-pair wire, co-axial cable, fiber optics, and so forth. The communications media may be connected to a node using an I/O adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 500 may include one or more wireless nodes arranged to communicate information over one or more types of wireless communication media, sometimes referred to herein as wireless shared media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transceivers, amplifiers, filters, control logic, and so forth. As used herein, the term “transceiver” may be used in a very general sense to include a transmitter, a receiver, or a combination of both. The embodiments are not limited in this context.

As shown, the communications system 500 may include a wireless node 510. In various embodiments, the wireless node 510 may be implemented as a wireless device such as wireless device 100. Examples of wireless node 510 also may include any of the previous examples for a node as previously described.

In one embodiment, for example, the wireless node 510 may comprise a receiver 511 and an antenna 512. The receiver 511 may be implemented, for example, by any suitable receiver for receiving electrical energy in accordance with a given set of performance or design constraints as desired for a particular implementation. In various embodiments, the antenna 512 may be similar in structure and operation the antenna structures 108, 208 described in relation to FIGS. 1-10. In some implementations, the antenna 512 may be configured for reception as well as transmission.

In various embodiments, the communications system 500 may include a wireless node 520. Wireless node 520 may comprise, for example, a mobile station or fixed station having wireless capabilities. Examples for wireless node 520 may include any of the examples given for wireless node 510, and further including a wireless access point, base station or node B, router, switch, hub, gateway, and so forth. In one embodiment, for example, wireless node 520 may comprise a base station for a cellular radiotelephone communications system. Although some embodiments may be described with wireless node 520 implemented as a base station by way of example, it may be appreciated that other embodiments may be implemented using other wireless devices as well. The embodiments are not limited in this context.

Communications between the wireless nodes 510, 520 may be performed over wireless shared media 522-1 in accordance with a number of wireless protocols. Examples of wireless protocols may include various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols. The embodiments are not limited in this context.

In one embodiment, wireless nodes 510, 520 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, the wireless nodes 510, 520 may be arranged to communicate using a number of different wireless wide area network (WWAN) data communication services. Examples of cellular data communication systems offering WWAN data communication services may include a GSM with General Packet Radio Service (GPRS) systems (GSM/GPRS), CDMA/1xRTT systems, Enhanced Data Rates for Global Evolution (EDGE) systems, Evolution Data Only or EVDO systems, Evolution for Data and Voice (EV-DV) systems, High Speed Downlink Packet Access (HSDPA) systems, and so forth. The embodiments are not limited in this respect.

In one embodiment, the communication system 500 may include a network 530 connected to the wireless node 520 by wired communications medium 522-2. The network 530 may comprise additional nodes and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. The network 530 also may include other cellular radio telephone system equipment, such as base stations, mobile subscriber centers, central offices, and so forth. The embodiments are not limited in this context.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. An antenna, comprising:
first and second resonating elements;
a signal feed coupled to the first and second resonating elements;
a ground conductor; and
a third resonating element coupled to the ground conductor;
wherein the third resonating element is positioned adjacent to one of the first and second resonating elements.

2. The antenna of claim 1, the first resonating element having a first portion and a second portion configured in an L-shape.

3. The antenna of claim 1, the second resonating element having a first section and a second section configured in an L-shape.

4. The antenna of claim 1, the ground conductor comprising at least a portion of a printed circuit board.

5. The antenna of claim 1, the first resonating element having a length that is greater than a length of the second resonating element.

6. The antenna of claim 1, the third resonating element positioned adjacent to the first resonating element.

7. The antenna of claim 1, the first, second and third resonating elements capable of producing at least three different resonances.

8. The antenna of claim 1, comprising a tuning element electrically coupled to the signal feed.

9. The antenna of claim 8, the tuning element positioned adjacent the second resonating element.

10. The antenna of claim 9, the tuning element having a geometry that is substantially the same as a geometry of the second resonating element.

11. A mobile computing device, comprising:
an applications processor, a radio processor, a display, and an antenna, the antenna comprising:
first and second resonating elements electrically coupled to a signal feed; and
a third resonating element coupled to a ground conductor.

12. The device of claim 11, each of the first and second resonating elements having a first portion and a second portion configured in an L-shape.

13. The device of claim 11, the first and second resonating elements being of unequal lengths.

14. The device of claim 11, the first resonating element being longer than the second resonating element, the third resonating element positioned adjacent to the first resonating element.

15. The device of claim 11, the first, second and third resonating elements configured to produce at least three different resonances.

16. The device of claim 11, comprising a tuning element electrically coupled to the signal feed and positioned adjacent to the second resonating element, the tuning element having a geometry substantially the same as a geometry of the second resonating element.

17. An antenna, comprising:
first, second and third resonating elements, the first and second resonating elements each having an L-shape;
a signal feed coupled to the first and second resonating elements; and
a ground conductor coupled to the third resonating element.

18. The antenna of claim 17, the first resonating element having a length greater than a length of the second resonating element, the third resonating element positioned adjacent the first resonating element.

19. The antenna of claim 18, comprising a tuning element coupled to the signal feed.

20. The antenna of claim 19, the tuning element positioned adjacent to the second resonating element and having a geometry that is similar to a geometry of the second resonating element.
